(19) United States
(12) Patent Application Publication
(10) Pub. No.: US 2009/0241603 A1
(43) Pub. Date: Oct. 1, 2009

(54) OPTICAL FIBER MANUFACTURING METHODS

(75) Inventor: Minsuk SONG, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: THE FURUKAWA ELECTRIC CO., LTD., Tokyo (JP)

(21) Appl. No.: 12/408,805

(22) Filed: Mar. 23, 2009

(30) Foreign Application Priority Data
Mar. 24, 2008 (JP) 2008-075910

(51) Int. Cl. C03B 37/02

(52) U.S. Cl. 65/435

(57) ABSTRACT

Optical fiber manufacturing methods, which manufacture optical fibers with uniform characteristics using a simple device construction, are provided. The optical fiber manufacturing methods comprise, drawing a glass fiber from a glass preform by heating and melting one end of the glass preform and coating at least one layer of resin around the circumference of the drawn glass fiber. The method includes the steps of decreasing the viscosity of the resin from an initial viscosity during a start-up process time to a steady viscosity as optical fiber draw speed increases, wherein the steady viscosity is a predetermined viscosity; and increasing the draw speed during the start-up process time to a faster steady speed.

### CROSS-REFERENCES TO RELATED APPLICATIONS

This application claims the benefit of priority from Japanese Patent Application No. 2008-075910 filed Mar. 24, 2008, the entire contents of which is incorporated herein by reference.

### TECHNICAL FIELD

The present invention is related to optical fiber manufacturing methods, which draw glass fiber from a glass preform by heating and melting one end of the glass preform, and coating at least one layer of resin around the circumference of the drawn glass fiber.

### BACKGROUND OF THE INVENTION

A Japanese Patent Application Laid-open No. 2001-247340 discloses a technique to solve leaking of a coating resin in a coating device due to reverse flow by blowing off the reversed resin by supplying compressed gas and sucking in the blown resin.

However, when the technique disclosed in the above application is used, because it requires a compressed gas supply and a device to suck the resin, it has an issue of complexity in the device construction. Moreover, the characteristics of the drawn optical fiber fluctuate because the resin supply is disturbed by the compressed gas supply, the resin suction, and the amount of coating of the drawn glass fiber changes.

### SUMMARY OF THE INVENTION

The present invention provides a method for manufacture optical fibers with consistent characteristics using a simple device construction.

To solve the above problems, the present invention discloses a method of drawing an optical fiber, wherein a glass optical fiber is drawn from a glass preform by heating and melting one end of the glass preform and coating at least one layer of resin around the circumference of the drawn glass fiber. The method comprises the steps of decreasing the viscosity of the resin from an initial viscosity during a start-up process time to a steady viscosity as optical fiber draw speed increases, wherein the steady viscosity is a predetermined viscosity; and increasing the draw speed during the start-up process time to a faster steady speed.

### BRIEF DESCRIPTION OF THE DRAWINGS

Referring now to the drawings:

FIG. 1 is a schematic drawing of overall construction of an optical fiber manufacturing apparatus used in embodiments of the present invention;

FIG. 2 is a schematic cross-sectional drawing of a coated optical fiber manufactured in the embodiments of the present invention;

FIG. 3 shows the construction of the resin-coating device of FIG. 1;

FIG. 4 is an expanded view of the vicinity of a first resin boundary face in a land portion in FIG. 3;

FIG. 5 shows a relationship between the change in optical fiber drawing speed (dashed line) and the change in viscosity of the first resin (solid line) in each process;

FIG. 6 shows another relationship between the change in optical fiber drawing speed (dashed line) and the change in the viscosity of the first resin (solid line) in each process; and

FIG. 7 shows yet another relationship between the change in optical fiber drawing speed (dashed line) and the change in viscosity of the first resin (solid line) in each process.

### DETAIL DESCRIPTION

Detailed descriptions optical fiber coating and manufacturing methods according to the present invention are set forth below referencing the above-mentioned figures. While various embodiments of the present invention are described below, it should be understood that they are presented by way of example, and are not intended to limit the scope of the invention.

### EMBODIMENTS OF THE PRESENT INVENTION

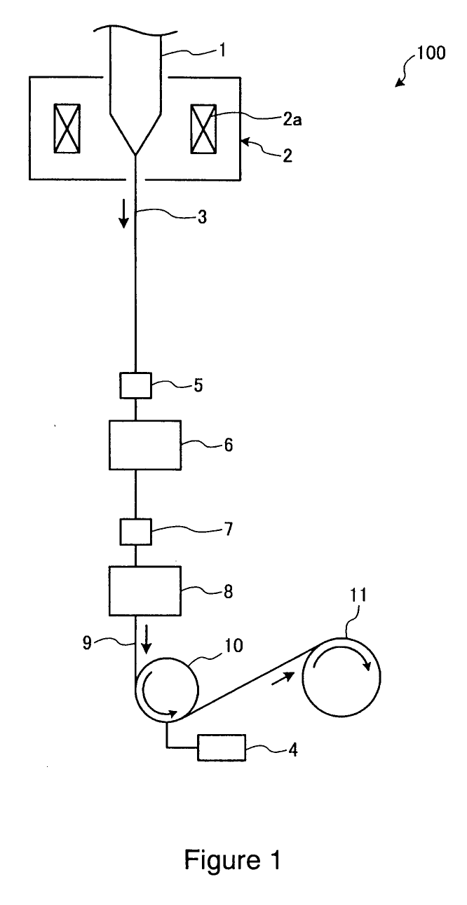

FIG. 1 is a schematic drawing of the overall constriction of an optical fiber manufacturing apparatus used in embodiments of the present invention. As shown in FIG. 1, an optical fiber manufacturing apparatus 100 includes a heater 2a; a drawing heating furnace 2 to heat and melt one end of a glass preform; resin-coating devices 5 and 7 to coat an ultraviolet-cured resin around the circumference of a glass optical fiber 3; resin-curing devices 6 and 8 to cure the coated resin; a capstan roller 10 to pull a coated optical fiber 9; and a take-up spool 11. The resin-curing devices 6 and 8 are, for example, ultraviolet irradiation devices. The capstan roller 10 is also equipped with a draw speed measuring device 4 and, based on the rotational speed of the capstan roller 10, the draw speed measuring device 4 measures the drawing speed of the optical fiber 9 drawn from a glass preform 1.

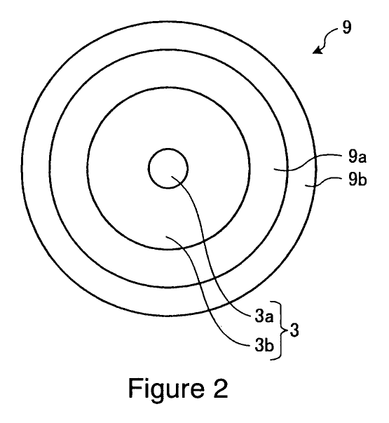

FIG. 2 is a schematic cross-sectional drawing of a coated optical fiber 9 manufactured according to the methods of the present invention. As shown in FIG. 2, the optical fiber 9 comprises of the glass fiber 3; a first coating layer 9a and a second coating layer 9b. The glass optical fiber 3, made from silica, has a core 3a (for example, approximately 10 μm in diameter) and a cladding 3b (approximately 125 μm in outer diameter) around the circumference of the core 3a. The outer diameter of the optical fiber 9 is, for example, approximately 250 μm. Also, a first resin and a second resin used for the first and second coating layers 9a and 9b, respectively, are selected to preserve the optical characteristics of the optical fiber 9 and to improve the durability and appearance of the optical fiber 9.

Next, optical fiber manufacturing methods relating to embodiments of the present invention are explained. First, in the optical fiber manufacturing apparatus 100, the glass preform 1, made from silica glass, is set in the drawing heating furnace 2. The heater 2a heats and melts the bottom portion of the glass preform 1, and glass fiber 3 is drawn from the glass preform 1. In this manufacturing method, the initial drawing of the glass optical fiber 3 is operated at relatively slow speed (for example 70 m/min.). Then, the drawing speed is increased gradually to a predetermined speed (for example 1,700 m/min.). Below, in the manufacturing methods, the process of increasing the drawing speed from the initial drawing speed is called a start-up process, and the process of keeping the drawing speed constant is called a steady process. Also, the time period of the start-up process is called a start-up process time (T1), and the time period of the start-up process is called a steady process time (T2). The drawing speed can be changed by, for example, changing the temperature of the heater 2a and/or pulling speed of the capstan roller 10.

Next, a resin-coating device 5 coats a first resin around the circumference of the drawn glass fiber 3, and the resin-curing device 6 cures the first resin and creates a first coating layer 9a.

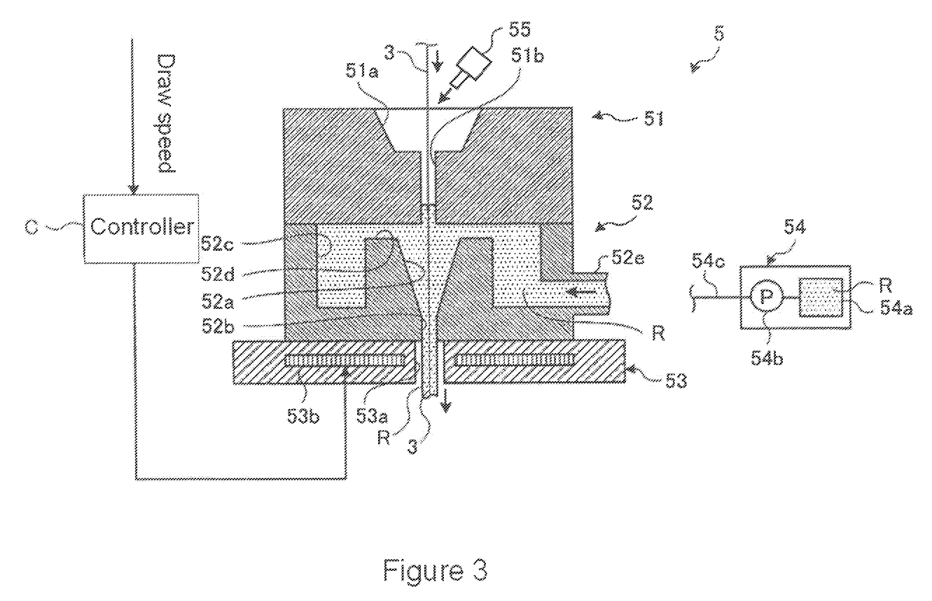

In the following, the construction of the resin-coating device 5 and the coating methods are explained in detail. FIG. 3 discloses the construction of the resin-coating device 5 shown in FIG. 1 and coating methods. As shown in FIG. 3, the resin-coating device 5 has a cylindrical shape nipple portion 51; a cylindrical shape die portion 52, which is connected to the lower side of the nipple portion 51; a die holder 53, which holds the die portion 52 from the lower side; a resin supply device 54, which supplies a resin to the die portion 52; a gas spray device 55, which sprays gas onto the nipple portion 51; and a controller C.

The nipple portion 51 has an optical fiber entry portion 51a, which is a circular opening and reduces its inner diameter as it extends toward the lower side and is placed near the central axis; and a land portion 51b, which has a circular opening with a constant inner diameter and is connected to the optical fiber entry portion 51a. The die portion 52 is placed on the same axis as the land portion 51b and has a diameter reduction portion 52a, which is a circular opening that reduces its inner diameter as it extends toward the lower side; a resin-forming portion 52b, which is a circular opening with a constant inner diameter and is connected to, and on the same axis as, the diameter reduction portion 52a; a resin storage portion 52c, which is a space surrounds the diameter reduction portion 52a; a connection portion 52d, which connects the diameter reduction portion 52a and the resin storage portion 52c; and a resin supply line 52e, which is placed at the outer surface of the die portion 52 and connected to the resin storage portion 52c.

The die holder 53 has an opening portion 53a, which is a circular opening with a constant inner diameter and is connected to, and on the same axis as, the resin-forming portion 52b; and a heater 53b. The resin supply device 54 has a resin supply tank 54a to store a resin R; a pump 54b, which supplies the first resin R stored in the resin supply tank 54a; and a supply pipe 54c, which connects the resin supply line 52e of the die portion 52 and supplies the first resin R from the pump 54b to the die portion 52. The gas spray device 55 is placed above the nipple portion 51 and sprays CO₂ gas to the optical fiber entry portion 51a of the nipple portion 51. The controller C receives information about optical fiber drawing speed and controls the heater 53b of the die holder 53 based on that information.

The resin-coating device 5 coats the first resin R onto the glass optical fiber 3 in the following manner. First, as shown in FIG. 3, the pump 54b of the resin supply device 54 sends out the first resin R stored in the resin supply tank 54a, and supplies it to the die portion 52 through the supply pipe 54c. Then, the resin storage portion 52c, the connection portion 52d, the reducing-diameter portion 52a and resin-forming portion 52b of the die portion 52 are filled with the first resin R. The resin storage portion 52c plays a role of reducing pressure change of the first resin R. The boundary face of the first resin R is placed within the land portion 51b of the nipple portion 51. The glass optical fiber 3 is inserted into the fiber entry portion 51a of the nipple portion 51. It then passes the land portion 51b, the reducing-diameter portion 52a and the resin-forming portion 52b of the die portion 52, and is removed from the opening portion 53a of the die holder 53. As a result, the first resin R, filled at the reducing-diameter portion 52a and the resin-forming portion 52b, is coated around the circumference of the glass fiber 3. The first resin R is controlled by the resin-forming portion 52b such that the outer diameter of the coating is within the desired range.

The controller C receives information about optical fiber drawing speed. In an initial start-up process, the output of the heater 53b in the die holder 53 is set to zero and the first resin R to be coated around the glass optical fiber 3 is kept at room temperature (for example 25° C.˜35° C.). Thereafter the controller C increases the temperature of the first resin R as the drawing speed increases during the start-up process time, and it controls the heater 53b to maintain the first resin R at a constant temperature during the steady process time.

In embodiments of the present invention, by controlling the heater 53b with the controller C as described above during the steady process time, the glass fiber 3 can be coated with the first resin R having a desirable predetermined viscosity; and, during the start-up process time (which drawing speed changes with time), the first resin R can be coated at a higher viscosity level than during the predetermined viscosity. As a result, resin leaking is prevented, and the first resin R can be coated onto the glass fiber 3 uniformly.

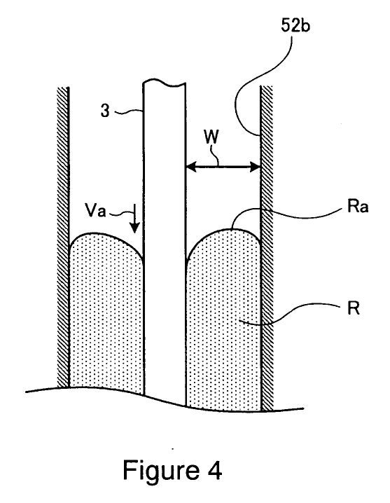

FIG. 4 is an expanded view in the vicinity of the first resin R boundary face Ra in the land portion 51b in FIG. 3. As shown in FIGS. 3 and 4, when the resin-coating device 5 coats the first resin R onto the glass fiber 3, the boundary face Ra of the first resin R in the land portion 51b has a convex meniscus shape as the glass fiber 3 moves downward. During the process, the drawing speed of the optical fiber is approximately constant and the height of the boundary face Ra is also stabilized. However, during the start-up process, because the drawing speed changes with time, the height of the boundary face can be changed easily.

If the rate of flow of the first resin R to the up steam is expressed as Q, the pressure within the resin-coating device 5 is P, the viscosity is μ, the clearance between the glass optical fiber 3 and the land portion 51b is w, and the drawing direction of the glass optical fiber 3 is the negative direction of the z-axis, then the following equation is driven from the Navier-Stokes equations:

Q=πw⁴/8μ(−dp/dz) (1)

As shown in the equation (1), the rate of flow of the first resin R to the upstream Q is inversely promotional to the viscosity, μ, of the first resin R. According to the relationship, in the embodiments of the present inventions, the viscosity, μ, of the first resin R during the start-up process time (the drawing speed changes with time) is higher than that in the steady process time. Therefore, the increase in the rate of flow of the first resin R to the upstream as the drawing speed increases can be suppressed, and the change in the height of the boundary face Ra can be suppressed as well. As a result, the resin leaking from the land portion 51 is prevented and the resin can be coated onto the glass optical fiber uniformly. Also, if the boundary face Ra change during the start-up process time is suppressed, and resin leaking in the proceeding steady process time is also less likely to occur.

If the viscosity of the resin is kept constant from the initial start-up process to a predetermined time in the start-up process time and then decrease (to that in the steady process time) after the predetermined time, then resin leaking can be suppressed without complex controls. Also, if the temperature of the resin is at the room temperature (e.g. 25° C.˜35° C.) at the initial start-up process time, then the control can be further simplified.

Also, changing the viscosity by controlling its temperature is one of the easiest ways to control the viscosity of the resin sent to the resin-coating device 5 continuously. It is desirable to understand the viscosity characteristics of the resin to be used against temperature beforehand, then controlling the resin temperature according to the characteristics. For example, controlling temperature to make resin viscosity to be more than 1.4 Pa·s at the initial start-up process can suppress resin leaking effectively.

As described above, the gas spray device 55 sprays CO₂ gas onto the optical fiber entry portion 51 of the nipple portion 51. Spraying with CO₂ gas prevents air bubble formation in the first resin because the boundary face Ra is filled with the CO₂ gas, whose dynamic viscosity coefficient is smaller than that of air. If resin leaking occurs, then the boundary face Ra of the first resin R is more likely to be exposed to air. In that case, air-bubbles may enters into the first resin R (even into the first coating layer 9a) and decreases the reliability of the optical fiber 9. However, according to the embodiments of present invention, since the resin leaking is prevented, any mixing of bubbles into the first resin R can be prevented as well.

Next, the glass fiber 3 with the first coating layer 9a is further coated with a second resin by resin-coating device 7 and then cured by the resin-curing device 8 to create a second layer 9b. Because the resin-coating device 7 has the same construction and provides the same control function as the resin-coating device 5, resin leaking is also prevented in the resin-coating device 7, and the second resin coating is applied uniformly onto the glass fiber 3 with the first coating layer 9a.

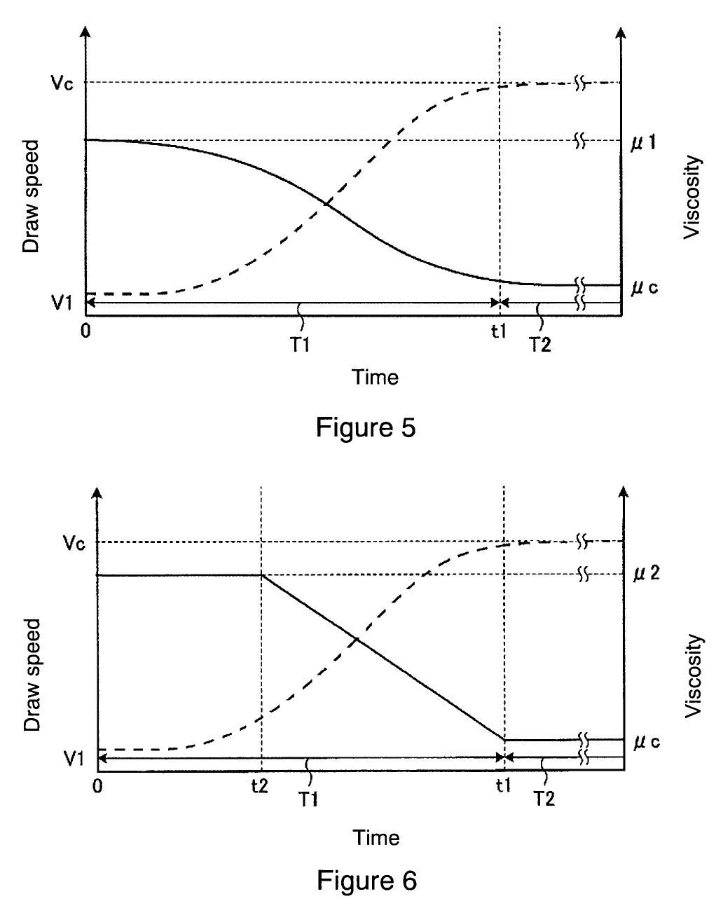

FIG. 5 shows the relationship between change in optical fiber drawing speed (dashed line) and change in the viscosity of the first resin R (solid line) in each process. In FIG. 5, the starting time of the drawing is set as an origin, from the starting time to time to is a start-up process time T1, and after time to is a steady process time T2. As shown in FIG. 5, in the embodiments of the present invention, initial drawing speed in the starting time of the drawing starts from V1, next the drawing speed is gradually increased during the start-up process time T1, and then the drawing speed is kept at the predetermined speed Vc in the steady process time T2. At the same time, the controller C sets the output of the heater 53b at zero to make the first resin R viscosity (μ1) in the starting time of the drawing higher than the desired predetermined viscosity μ at the steady process time T2. Then the controller C gradually reduces the viscosity to the predetermined viscosity μc as the drawing speed increases during the start-up process time T1. In the steady process time T2, the controller C causes the viscosity to become the predetermined viscosity μc. In addition, the relationship between the change in optical fiber drawing speed and the change in viscosity of the second resin can be expressed in a pattern similar to FIG. 5.

As explained above, according to the embodiments of the present invention, it is possible to provide consistent resin coating with a simple devise construction and manufacture optical fibers with consistent characteristics.

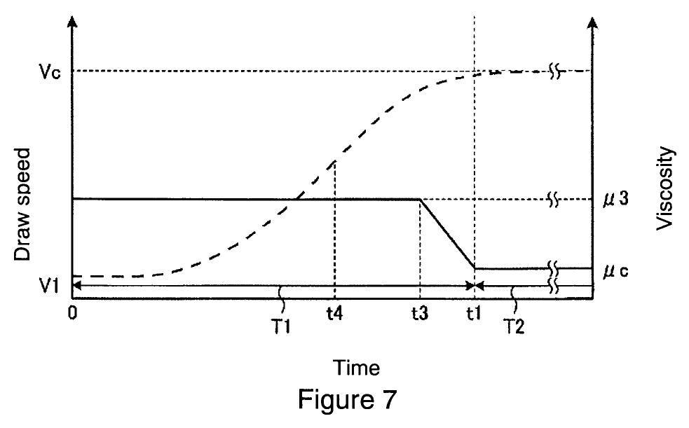

In addition, the relationship between change in optical fiber drawing speed and change in viscosity of the first resin R is not limited to the relationship shown in FIG. 5. FIGS. 6 and 7 show other relationships between change in the optical fiber drawing speed (dashed line) and change in the viscosity of the first resin R (solid line) in each process. In the case of FIG. 6, the change in optical fiber drawing speed is the same as in FIG. 5; however, the viscosity of the first resin R is kept at a constant value μ2 until a predetermined time t2 during the start-up process time T1, and then after t2 the viscosity is gradually lowered to reach the predetermined viscosity μc. The above viscosity control can be done by, for example, by setting the heater 53b off between the initial start-up time and the predetermined time t2. Thereafter the output of heater 53b is set to the desired amount.

In the case of FIG. 7, the change in optical fiber drawing speed is the same as in FIGS. 5 and 6; however, the viscosity of the first resin R is kept at a constant value μ3 until a predetermined time t3 during the start-up process time T1. Thereafter, the viscosity is lowered to reach the predetermined viscosity μc. The predetermined time t3 is after a time t4, in which the optical fiber drawing speed changes most rapidly during the start-up process time T1. As stated above, by setting the time to start lowering the viscosity of the first resin R after the time t4, in which the optical fiber drawing speed changes most rapidly, high viscosity resin can be provided at the time t4 and provide more definitive control toward preventing the resin leaking. In addition, the relationship between the change in optical fiber drawing speed and change in viscosity of the second resin can be expressed in a pattern similar to FIGS. 6 and 7.

Also, the method to change the resin viscosity is not limited to temperature control of the resin. It can be done by controlling composition of the resin and/or concentration of the resin.

### EXAMPLES 1 AND 2, AND COMPARATIVE EXAMPLE 1

Next, as examples 1 and 2 and a comparative example 1 of the present invention, optical fibers are manufactured using the same manufacturing apparatus as described in the above embodiments. In examples 1 and 2 and comparative example 1, the initial drawing speed in the start-up process is 70 m/min and then the speed is gradually increased to a predetermined speed of 1,700 m/min during the steady process. In the resin-coating device, the first coating is applied with the temperature of the resin kept at the desired temperature of the steady process time. The drawing speed changes most rapidly when it reaches 600-700 m/min. In example 1, in the second coating layer, the resin temperature is kept at room temperature of 30° C. until the drawing speed reaches to 1,000 m/min from the initial drawing speed. Then, the resin temperature is gradually increased and kept at 50° C. during the steady process time. The resin for the second coating layer has a viscosity of 3.0 Pa·s at 30° C., and a viscosity of 0.65 Pa·s at 50° C. When 1,000,000 km of optical fiber is made by the above apparatus, the frequency of resin leaking during the start-up process time is below 0.005 times/1,000 km, and the resin leaking does not occur during the steady process time.

In example 2, in the second coating layer, the resin temperature is kept at 40° C. until the drawing speed reaches to 1,000 m/min from the initial start-up process time. Then, the resin temperature is gradually increased and kept at 50° C. during the steady process time. The resin for the second coating layer has a viscosity of 1.45 Pa·s at 40° C., and a viscosity of 0.65 Pa·s at 50° C. When 1,000,000 km of optical fiber is made by the above apparatus, the frequency of resin leaking during the start-up process time is 0.01 times/1,000 km, and resin leaking does not occur during the steady process time.

In comparative example 1, in the second coating layer, the resin temperature is kept at 50° C. in both the start-up process time and the steady process time. When 1,000,000 km of optical fiber is made by the above apparatus, the frequency of resin leaking during the start-up process time is 0.05 times/1000 km, and resin leaking occurs during the steady process time as well.

What is claimed is:

1. A method of manufacturing an optical fiber, wherein a glass fiber is drawn from a glass preform by heating and melting one end of the glass preform and coating at least one layer of a resin around the circumference of the drawn glass fiber, the method comprising the steps of:
decreasing the viscosity of the resin from an initial viscosity during a start-up process time to a steady viscosity as optical fiber draw speed increases, wherein the steady viscosity is a predetermined viscosity; and
increasing the draw speed during the start-up process time to a faster steady speed.

2. The method of manufacturing an optical fiber in claim 1, wherein the viscosity of the resin is kept relatively constant until a predetermined time in the start-up process time, after the predetermined time, the viscosity of the resin is decreased to the predetermined viscosity.

3. The method of manufacturing an optical fiber in claim 1, wherein the viscosity of the resin is more than 1.4 Pa·s at a initial start-up process time.

4. The method of manufacturing an optical fiber in claim 1, wherein the viscosity of the resin is changed by controlling the resin temperature.

5. The method of manufacturing an optical fiber in claim 1, wherein the resin temperature at a initial start-up process time is at between 25° C. and 35° C.
